(19) United States
(12) Patent Application Publication
(10) Pub. No.: US 2016/0364817 A1
(43) Pub. Date: Dec. 15, 2016

(54) System, Method, and Apparatus for Utilizing Multi-Processing to Optimize Calculations of Licensable Properties

(71) Applicant: Glenn Barber, Irvine, CA (US)

(72) Inventor: Glenn Barber, Irvine, CA (US)

(21) Appl. No.: 15/179,965

(22) Filed: Jun. 10, 2016

Related U.S. Application Data
(60) Provisional application No. 62/174,704, filed on Jun. 12, 2015.

(51) Int. Cl. G06Q 50/18; G06F 9/52; G06Q 10/06

(52) U.S. Cl. CPC G06Q 50/184; G06Q 10/06316; G06F 9/52

(57) ABSTRACT

The invention takes advantage of multi-processing by separating independent aspects of calculation and reporting of licensable properties and assigning them to individual processing tasks. System, method, and apparatus, are provided for utilizing multi-processing to optimize calculations of licensable properties. The invention provides for defining the number of tasks to perform calculations with maximum throughput, assigning a distinct list of properties requiring processing to each task, executing multiple parallel Calculation Process tasks, each with a distinct task identifier and configured to read its list of properties, perform calculations and output results for each property, and terminate upon completion of its assigned list of properties.

### CROSS REFERENCE TO RELATED APPLICATIONS

This application claims priority from a provisional U.S. patent application No. 62/174,704 filed on Jun. 12, 2015.

### FIELD OF THE INVENTION

Embodiments of the invention generally relate to multi-processing systems. Specifically, embodiments of the invention relate to processing calculations and reporting of licensable properties utilizing multi-processing systems.

### BACKGROUND OF THE INVENTION

Modern multi-processor and multi-core servers combined with a modern operating system (“OS”), enable the simultaneous running of separate processing tasks in separate computer cores (i.e. multi-processing). This allows each separate computing task to have independent access to processing resources and data stored in databases located in memory and on disks.

Owners of intellectual property often use an intellectual property management system to track their ownership rights and license agreements. The property rights s and license are often stored in very large databases. Many of these systems perform complex calculations to determine and report which properties (patents, movies, books, etc.) and respective rights have been granted/licensed in which territories and which properties and respective rights are available to license in which territories and for what period of time. This is a large multi-dimensional calculation of the availability to license of Properties, Rights, Territories, Languages and other attributes within a time period. As the volume and complication of License Agreements can be large and processing of these reports on a daily basis can take a significant amount of time, there is a need to keep current records of licensing and availability by performing these calculations in a more efficient way.

### SUMMARY

Generally, in intellectual property management systems, there exists a process that performs calculations to determine and report which properties and respective rights have been granted/licensed in which territories and which properties and respective rights are available to license in which territories and for what period of time. The invention takes advantage of multi-processing by separating independent aspects of calculation and reporting and assigning these separate processing tasks to separate programs which can be run simultaneously in a multi-processing environment achieving throughput in calculations many times that which could be achieved in by a single process.

In accordance with the teachings of the present invention, system, method, and apparatus are provided for utilizing multi-processing to optimize calculations of licensable properties. The invention provides for defining the number of tasks to perform calculations with maximum throughput, assigning a distinct list of properties requiring processing to each task, executing multiple parallel Calculation Process tasks, each with a distinct task identifier and configured to read its list of properties, perform calculations and output results for each property, and terminate upon completion of its assigned list of properties.

The tasks can be run a on single computer or on multiple computers. Assigning a list of properties requiring processing to each task can be done to provide for a relatively equal proportion of calculation effort assigned to each task for maximum processing throughput. This can be determined using each property's license activity, prior processing history, or a combination of license activity and prior processing history

Alternatively, the invention provides for defining the number of tasks to perform calculations with maximum throughput, executing multiple parallel Calculation Process tasks, each with a distinct task identifier, configuring each Calculation Process to request a property to process, providing a property to a Calculation Process upon receiving a request for a property, configuring each Calculation Process to perform calculations and output results for the property and upon completion request a new property to process, and terminating a Calculation Process upon a request for a property if there are no more properties to process. The Executive Process and Calculation Processes can communicate with each other by interprocess messaging or reading from and writing to a database.

### BRIEF DESCRIPTION OF THE DRAWINGS

The accompanying drawings taken in conjunction with the detailed description will assist in making the advantages and aspects of the disclosure more apparent.

FIG. 1 is a database table layout for a license and its property grants.

FIG. 2 is a database table layout for the property list and task list table.

FIG. 3 is a flowchart of how multi-processing is utilized to perform the calculations.

FIG. 4 is an alternative flowchart of how multi-processing is utilized to perform the calculations.

FIG. 5 is a block diagram of a general system embodiment on a single computer.

FIG. 6 is a block diagram of an alternative system embodiment on multiple computers.

### DETAILED DESCRIPTION

Reference will now be made in detail to the present embodiments discussed herein, illustrated in the accompanying drawings. The embodiments are described below to explain the disclosed system, method and apparatus by referring to the Figures using like numerals. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

The subject matter is presented in the general context of system and program modules that are able to read from and write data to memory, databases, or similar. Those skilled in the art will recognize that other implementations may be performed that may include different data structures, components, or routines that perform similar tasks. The invention can be practiced using various computer system configurations, such as client server systems. Other usable systems can include, but are not limited to, mainframe computers, microprocessors, personal computers, smart phones, tablets, and other consumer electronic devices. Such computer devices may include one or more processors, data storage in the form of memory (hard disk, random access memory, cache memory, etc.), a database, and an OS.

System, method, and apparatus for utilizing multi-processing to optimize calculations of licensable properties are provided. This invention shall apply to licensable intellectual property and the determination and reporting of which property licenses have been granted in which territories and which property rights are still available to license. This invention improves the efficiency of such processing.

The invention takes advantage of multi-processing by separating independent aspects of calculation and reporting and assigning these separate processing tasks to separate programs which can be run simultaneously in a multi-processing environment achieving throughput in calculations many times that which could be achieved in by a single process. To further achieve maximum throughput in independent calculations, the OS and computer hardware may be configured to prioritize the processing of the independent tasks and assigning them each independent processing cores, allowing them to run simultaneously while maximizing all available processing and memory^{,} resources. Further, in order to optimize processing, an equal proportion of processing can be assigned to each task.

The acquisition of property rights and sale of property rights are generally entered into a system by a user on a license by license level. A license can be stored as a license header with general license information and the license grants identifying the properties, rights, and territories granted.

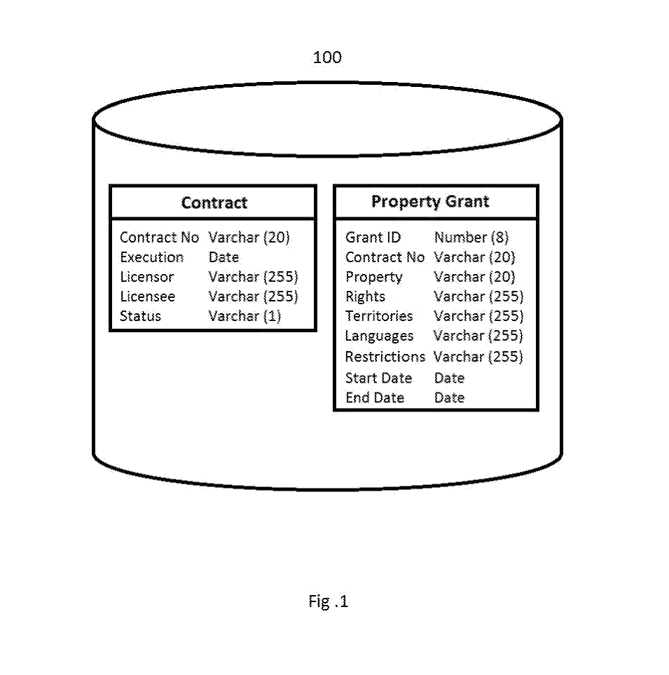

As illustrated in FIG. 1, a database table layout 100 of the License and Property Grant tables are provided.

A license can be stored as a license header and the grants in separate tables. A typical License header table includes a License No., a unique key identifying the license. Other relevant data for a license can include the license execution date, licensor and licensee. A status identifying a license as pending, executed, terminated or any other relevant status is also common.

In a separate subordinate table, a typical Property Grant table includes a Grant ID, a unique key for each row, and a License No. referring back to the license header table. Each row contains a single property, a list of rights granted, a list of territories in which the grants occur, languages in which the property is granted, and other restrictions such as exclusivity. Lastly, a grant would typically include the start and end date of the grant period.

This database layout stores a single license as distinct grants for each property. Other database table layouts may vary in further depicting the granularity of grants over additional tables for different rights, territories, languages and the like. This database layout illustrates that grants of properties are distinct from grants of other properties and can be stored in such a way. With varying database layouts, it is only necessary that license grants be stored in a manner in a database so that it can be indexed and accessed by properties.

By storing a license and the grants differentiated by property, the grants of one property do not impact the grants of another property even within the same license. The determination and reporting of which property licenses have been granted in which territories and which property^{,} rights are still available to license can be achieved by processing grants by property across multiple agreements. For example, a calculation of Property A would involve the retrieval of all Property A records from the property grant table, regardless of the license. By utilizing multi-processing on modern computer processors, calculations on a property level can be efficiently achieved.

Generally, in intellectual property management systems, there exists some form of Calculation Process. Such a process performs calculations to determine and report which properties and respective rights have been granted/licensed in which territories and which properties and respective rights are available to license in which territories and for what period of time. In such property management systems, the Calculation Process can be run for various user specified selection criteria or can be run for the entire library of properties. In the present embodiment, the Calculation Process is modified to be driven by the Executive Process. The Executive Process utilizes a property list table where each record corresponds to each unique property to be processed. The Executive Process additionally utilizes a task list where each record represents a distinct processing task.

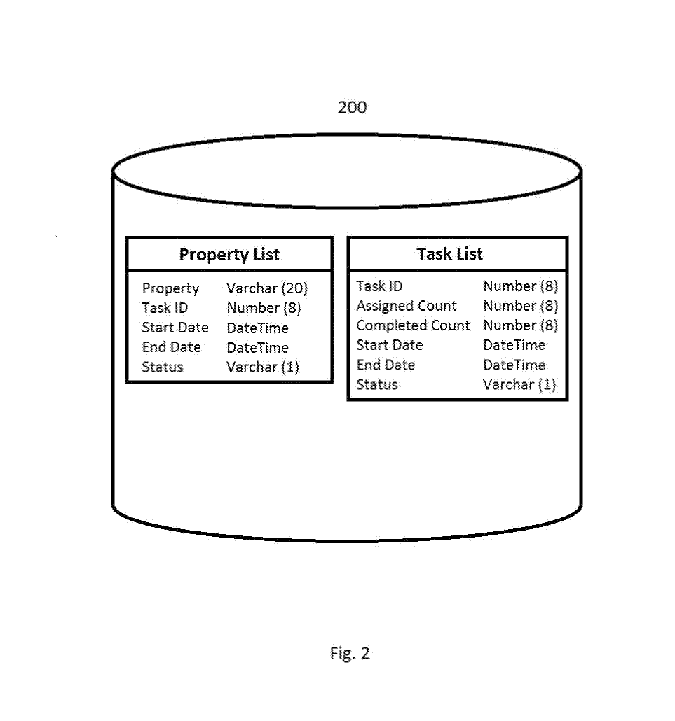

As illustrated in FIG. 2, a database table layout 200 of the property list and task list tables are provided.

The property list table includes the Property as a unique key identifying the property to be processed. The Task ID identifies the task that will process the property. A process Start DateTime and End DateTime timestamps are beneficial to keep track of the date and time the processing of each property was started and completed. Lastly, a Status field can identify the calculation of a property as unprocessed, in progress, completed or any other relevant status.

The task list table includes a Task ID, a unique key, which identifies each separate processing task. The number of properties to be processed assigned to each task is stored in the Assigned Count and the number of properties finished processing is stored in the Completed Count. A Start DateTime and End DateTime timestamps are beneficial to keep track of the date and time each task was started and completed. Lastly, a Status field can identify a task as unprocessed, in progress, completed or any other relevant status.

This invention provides for an Executive Process to execute and manage multiple simultaneous instances of the Calculation Process, which has been configured to take instruction from and interact with the Executive Process.

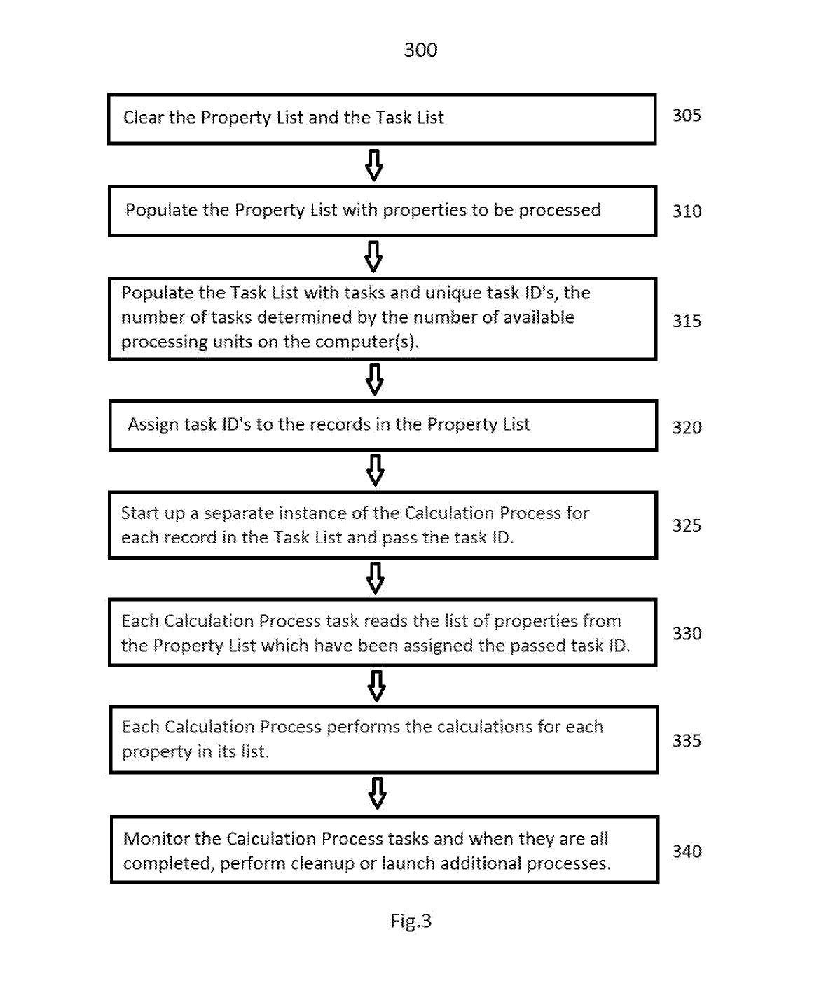

As illustrated in FIG. 3, a flowchart 300 of the multi-processing calculation setup and execution is provided.

The Executive Process clears the property list and the task list 305. The Property List is populated with A of the properties to be processed 310. The properties to be processed can be determined by user specified selection criteria, can be the entire property library, or can be determined by some other means. The number of tasks in the Task List is the optimal number that can be dedicated to doing the calculations in parallel as determined by throughput testing 315. This number can vary with number of processing units, the operating system, and other computing resources. Each record in the Task List is assigned a unique task identifier.

The task identifiers are then individually assigned to the records in the Property List so as to make sure each property record in the Property List is assigned a specific task identifier 320. This assigns a distinct set of properties to each task, so that each task can run simultaneously to perform calculations and output results for its list of properties. The properties can be assigned in alphabetical/ascending or some other arbitrary means. Alternatively, the task identifiers are assigned to property list records in a manner which provides for a relatively equal proportion of calculation effort assigned to each task so as to optimize the computing effort. This optimization results in a more equal calculation time for each task, resulting in the shortest overall processing time for all properties.

One implementation attempts to assign a relatively equal proportion of calculation effort to each task by determining the volume of licensing activity, since more licensing activity generally would require more calculation effort. This can be done by retrieving the number of grants for each property as stored the Property Grant table. In implementations that involve multiple tables for expressing grants as distinct tables for property, territories, languages and rights, a similar retrieval of the number of grants can be made by joining the tables. This count of relative license activity for each property can then be used to sort the properties and assign them to tasks so that each task will be assigned properties with a relatively equal amount of licensing activity, which translates to a relatively equal amount of calculation effort, time, and resources required for each task.

Another implementation attempts to assign a relatively equal proportion of calculation effort to each task by using the prior processing time for each property. In such implementations, the time to perform calculations of each property is determined, using the Start DateTime and End DateTime, and saved each time the property is processed. This most recent processing time can later be retrieved for each property. The prior processing time of each property can then be used to sort the properties and assign them to tasks so that each task will be assigned properties with a relatively equal prior processing time, which translates to a relatively equal amount of calculation effort, time, and resources required for each task.

Further, other implementations may combine the use of licensing activity and prior processing time to assign a relatively equal proportion of calculation effort to each task. Using licensing activity can be beneficial when a prior processing time will not accurately predict the current processing time due to a large increase (from new licenses) or large decrease (from expired licenses) in licensing activity since the previous processing. Additionally, the property can be new and have no prior processing history. Additionally, using the prior processing history can be beneficial when licensing activity may not accurately predict processing time (due to many concurrent non-exclusive licenses).

After the task assignments are complete, the Executive Process reads the task list and starts up a separate instance of the Calculation Process for each record in the Task List, passing the corresponding task ID to the Calculation Process instance 325. These Calculation Processes can be initiated on one or several processors to maximize the calculation process throughput. This assignment of Calculation Process tasks to processing units can be done automatically by the OS or can be assigned to specific processing units if the OS supports the functionality. After the Executive Process starts up a specific instance of a Calculation Process, it updates the task status of the corresponding record in the Task List to indicate that the task is now in progress. The Executive Process monitors the status of all of the assigned tasks. After being started up by the Executive Process, each separate Calculation Process task then reads the properties from the Property List 330, that have been assigned its task ID as passed to the Calculation Process task by the Executive Process at startup. This is done by retrieving from the Property List all records where Task ID is equal to the Calculation Process task number.

The Calculation Process then performs the availability and sale reporting calculations for each such property in the assigned list in sequence 335. The corresponding Property List record is updated to indicate the processing status for that property. When the Calculation Process has completed its calculations for all properties in the Property List assigned to its Task ID, the Calculation Process updates the corresponding Task List record to identify that the processing for that Task is complete.

The Executive Process monitors the status of the individual Calculation Process tasks and determines when they are all completed 340. Then, the Executive Process can perform any cleanup or reporting processes or launch additional processes which depend on the calculations already performed.

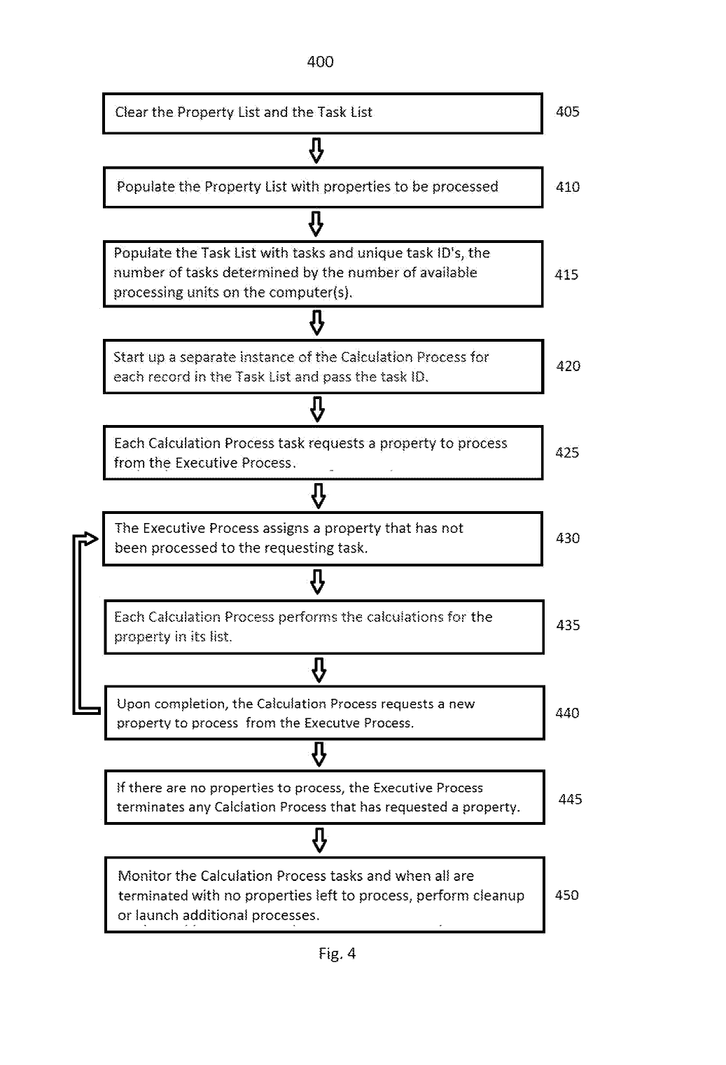

Instead of assigning tasks to all properties prior to processing, an alternative implementation assigns tasks to properties as the tasks become available for processing. As illustrated in FIG. 4, a flowchart 400 of an alternative multi-processing setup and execution is provided.

The Executive Process clears the property list and the task list 405. The Property List is populated with all of the properties to be processed 410. The properties to be processed can be determined by user specified selection criteria, can be the entire property library or can be determined by some other means. The number tasks in the Task List is the optimal number that can be dedicated to doing the calculations as determined by throughput testing 415. This number can vary with the number of processing units, the operating system, and other computing resources. Each record in the Task List is assigned a unique task identifier.

The Executive Process reads the task list and starts up a separate instance of the Calculation Process for each record in the Task List, passing the corresponding task ID to the Calculation Process instance to 420. These Calculation Processes can be initiated on one or several processors to maximize the calculation process throughput. This assignment of Calculation Process tasks to processing units can be done automatically by the OS or can be assigned to specific processing units if the OS supports the functionality. After the Executive Process starts up a specific instance of a Calculation Process, it updates the task status of the corresponding record in the Task List to indicate that the task is now in progress. The Executive Process monitors the status of all of the assigned tasks. After being started up by the Executive Process, each separate Calculation Process task then requests a property to process from the Executive Process 425. This can be done by the Calculation Process writing the request to a database or via interprocess messaging. Additionally, the Executive Process is configured to handle a queue of requests, since the Calculation Process tasks will be functioning and making requests independent from each other.

The Executive Process manages and assigns a property to the requesting task 430. The Executive Process determines if there are any properties in the Property List that have not been processed, as indicated by the property status. If there are unprocessed properties, the Executive Process passes the next available property to be processed directly to the Calculation Process via a process communication channel. Alternatively, the Executive Process can write the task identifier corresponding to the requesting task to the Property List record for the next available property to be processed. The Calculation Process can then retrieve a property from the Property List where Task ID is equal to the Calculation Process task number and the status indicates that the property has not been processed yet. The Calculation Process should be configured to go into a wait state if the retrieval of a property is unsuccessful. It remains in the wait state for a particular time until it gets another property or a direction from the Executive Process to terminate.

The Calculation Process then performs the availability and sale reporting calculations for the property 435. The corresponding Property List record is updated to indicate the processing status for that property. When the Calculation Process has completed its calculations for the property assigned to its Task ID, the Calculation Process updates the corresponding Property List record to identify that the processing for that property is complete. Each Calculation Process task, upon completion of calculations for its property, then requests a new property to process from the Executive Process 440.

The Executive Process, after determining if there are any properties in the Property List that have not been processed, assigns a new property to the requesting task 430. The Calculation Process then performs the availability and sale reporting calculations for the property 435. This continues for each Calculation Process until all properties are processed.

The Executive Process can be configured to terminate a Calculation Process (or cause the Calculation Process to terminate itself) if there are no properties left to satisfy the request by the Calculation Process 445. The Executive Process monitors the status of the individual Calculation Process tasks and the Property List and determines when there are no more active Calculation Process tasks and the Property List has been completely processed 450. Then, the Executive Process can perform any cleanup or reporting processes or launch additional processes which depend on the calculations already performed.

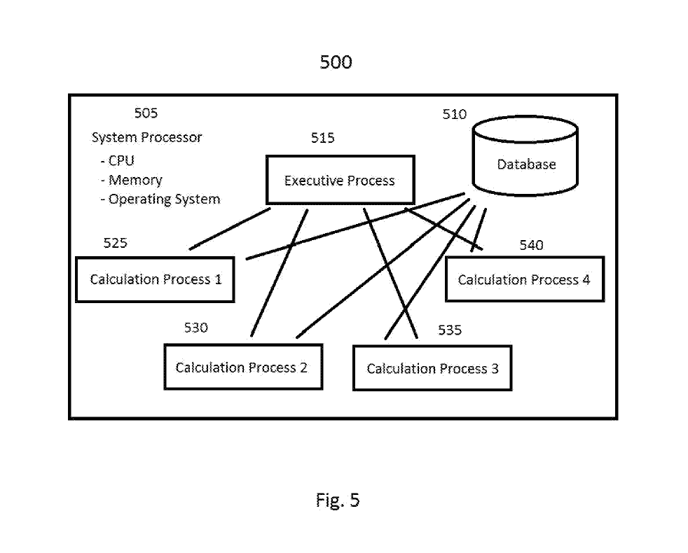

As illustrated in FIG. 5, a block diagram 500 of a general system embodiment on a single computer device, is provided.

In a general system embodiment, one System Processor 505 performs all necessary routines. Some components of the computer include multiple processing units, memory (hard disk, random access memory, cache memory, etc.), an OS, and a database 510. The System Processor 505 is configured to execute the Executive Process 515. The Executive Process 515 defines the number of tasks to perform calculations with maximum throughput. The Executive Process runs and manages the Calculation Processes 520, 525, 530, 535, with corresponding task identifiers, and reads from and writes to database 510. Each Calculation Process 520, 525, 530, 535 runs independently of the others, communicates with the Executive Process 515 and reads and writes to database 510. Embodiments can vary between a system that assigns a list of properties to each task prior to calculation and a system that assigns tasks to properties as the tasks become available for processing.

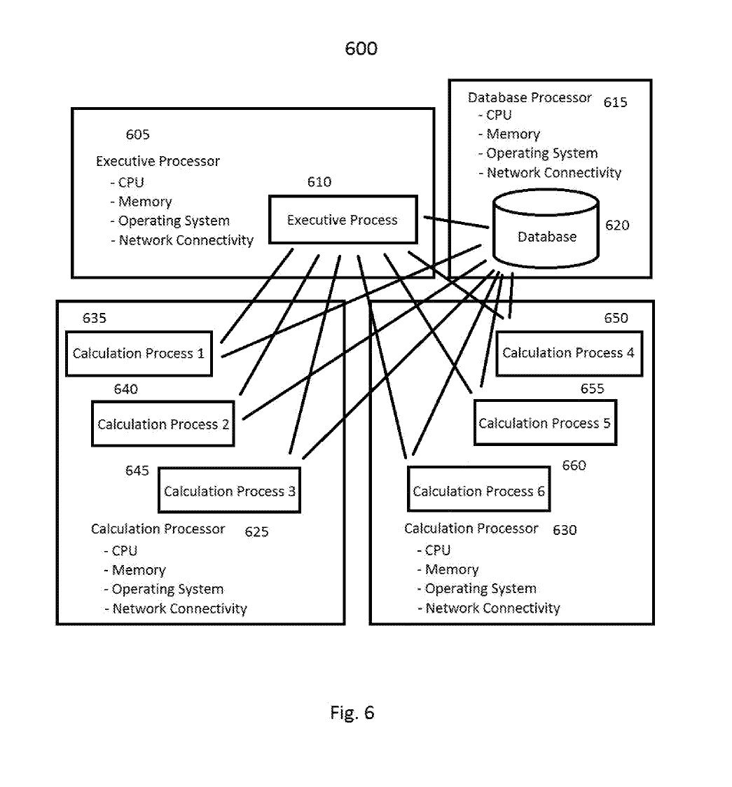

As illustrated in FIG. 6, a block diagram 600 of a system embodiment across multiple computer device, is provided.

In a system embodiment over two or more computers in a distributed network, two or more computers 605, 615, 625, 630 perform all necessary routines. Some components of the computers include multiple processing units, memory (hard disk, random access memory cache memory, etc.), an OS, and network connectivity. Multiple servers, each with one or more processor units, may be utilized. As depicted, an Executive Processor 605 is configured to execute the Executive Process 610. The Executive Process defines the number of tasks to perform calculations with maximum throughput. The Executive Process 610 runs and manages the Calculation Processes 635, 640, 645, 650, 655, 660, with corresponding task identifiers, on one or more Calculation Processors 625, 630 and reads from and writes to the database 620 on the Database Processor 615. Each Calculation Process 635, 640, 645, 650, 655, 660 runs independently of the others, communicates with the Executive Process 610 and reads from and writes to database 620. Embodiments can vary between a system that assigns a list of properties to each task prior to calculation and system that assigns tasks to properties as the tasks become available for processing.

In an embodiment over multiple computers, the Executive Processor is configured to manage the system. This can include defining the number of tasks to perform calculations with maximum throughput, assigning a distinct list of properties requiring processing to each task, and executing multiple parallel Calculation Process tasks. In other embodiments where the Executive Process will receive property requests from the Calculation Process tasks, this can include defining the number of tasks to perform calculations with maximum throughput, executing multiple parallel Calculation Process tasks, each with a distinct task identifier, properties to a Calculation Process upon a request for a property, terminating a Calculation Process upon a request for a property if there are no more properties to process.

The preceding description contains embodiments of the invention and no limitation of the scope is thereby intended.

That which is claimed is:

1. A method for utilizing multi-processing to optimize calculations of licensable properties comprising:
Defining the number of tasks to perform calculations with maximum throughput;
Assigning a distinct list of properties requiring processing to each task;
Executing multiple parallel Calculation Process tasks, each with a distinct task identifier and configured to read its list of properties, perform calculations and output results for each property, and terminate upon completion of its assigned list of properties.

2. The method of claim 1, wherein the tasks are on multiple computers.

3. The method of claim 1, wherein assigning a list of properties requiring processing to each task provides for a relatively equal proportion of calculation effort assigned to each task for maximum processing throughput.

4. The method of claim 3, wherein a relatively equal proportion of calculation effort assigned to each is based on each property's license activity

5. The method of claim 3, wherein a relatively equal proportion of calculation effort assigned to each is based on each property's prior processing history

6. The method of claim 3, wherein a relatively equal proportion of calculation effort assigned to each task is based on a combination of each property's license activity and prior processing history

7. A system utilizing multi-processing to optimize calculations of licensable properties comprising at least one processor, the at least one processor configured to cause the system to at least perform:
Defining the number of tasks to perform calculations with maximum throughput;
Executing multiple parallel Calculation Process tasks, each with a distinct task identifier;
Configuring each Calculation Process to y to process;
Providing a property to a Calculation Process upon receiving a request for a property Configuring each Calculation Process to perform calculations and output results for the property and upon completion request a new property to process;
Terminating a Calculation Process upon a request for a property if there are no more properties to process.

8. The system of claim 7, wherein the tasks are on multiple computers

9. The system of claim 7, wherein requesting a property to process and providing a property to process are done by interprocess messaging.

10. The system of claim 7, wherein requests for a property to process and providing a property to process are done by reading and writing to the database.

11. An apparatus for managing the utilization of multi-processing to optimize calculations of licensable properties comprising at least one processor, the at least one processor configured to at least perform:
Defining the number of tasks to perform calculations with maximum throughput;
Executing multiple parallel Calculation Process tasks, each with a distinct task identifier
Providing properties to a Calculation Process upon a request for a property
Terminating a Calculation Process upon a request for a property if there are no more properties to process.

12. The apparatus of claim 11, wherein providing properties to a Calculation Process is done by interprocess messaging.

13. The apparatus of claim 11, wherein providing properties to a Calculation Process is done by reading and writing to the database.
